(19) United States
(12) Patent Application Publication
(10) Pub. No.: US 2006/0153749 A1
(43) Pub. Date: Jul. 13, 2006

(54) Device for purifying used air containing harmful substances

(76) Inventor: Werner Schroder, Bad Nenndorf (DE)

Correspondence Address: SHLESINGER, ARKWRIGHT & GARVEY LLP;PATENT, TRADEMARK & COPYRIGHT LAW, SUITE 600, 1420 KING STREET, ALEXANDRIA, VA, 22314, US

(21) Appl. No.: 11/317,250

(22) Filed: Dec. 27, 2005

Related U.S. Application Data
(63) Continuation of application No. PCT/EP04/07237, filed on Jul. 2, 2004.

(30) Foreign Application Priority Data
Jul. 3, 2003 (DE) 103 30 114.3

(51) Int. Cl. B01J 19/12

(52) U.S. Cl. 422/186.3

(57) ABSTRACT

The invention relates to a device for purifying used air containing harmful substances, comprising a reaction stage according to the photooxidation principle. The reaction stage encompasses at least one air conduit inside which a tubular UV emitter is disposed along the direction of flow of the used air. In order to increase the decomposition rate within the used air conduit in a simple manner, the cross section of the at least one air conduit is embodied as a regular polygon having at least five sides.

### RELATED APPLICATIONS

This is a continuation of PCT/EP2004/007237, filed on Jul. 2, 2004, which claims the priority benefit of Germany application DE 103 30 114.3, filed on Jul. 3, 2003. Both applications are hereby incorporated by reference.

### FIELD OF THE INVENTION

The invention relates to a device for purifying used air containing harmful substances in a used air duct.

### BACKGROUND OF THE INVENTION

A device of this type for purifying used air containing harmful substances is known from EP 0 778 080 B1.

The invention further relates to a reaction stage of a used air duct comprising at least one air conduit, in which a tubular UV emitter is arranged longitudinally to the direction of flow of the used air.

A reaction stage of this type of a used air duct is known from JP 07-060058 A.

It is known from EP 0 778 080 B1 photo-oxidatively to react, in a reaction stage, harmful substances such as solvents or odorous substances by irradiating the used air with high-energy UVC light in an air conduit. It is, in principle, also known to arrange in parallel a plurality of air conduits to increase the degree of effectiveness. The reactive species required for the decomposition of harmful substances are produced owing to the interaction of UVC radiation and used air. The oxidants ozone, hydrogen peroxide and O and OH radicals are produced as a result of the absorption of UVC light by oxygen and water molecules of the used air. These oxidants have high oxidation potentials and are therefore able to oxidise harmful substances. A chain reaction is initiated in which new radicals, which may, in turn, attack other molecules, are produced. In addition, the UVC radiation is absorbed by the harmful substance molecules and the decomposition products thereof. As a result of the absorption of light energy, the harmful substances are stimulated to higher energy levels and are therefore activated for reaction with the reactive species or else with atmospheric oxygen. If sufficient light energy is supplied, the molecule decomposes. The decomposition products of the photolysis of the harmful substances may also form OH radicals or initiate radical chain reactions. Homogeneous gas phase reactions start owing to the photoexcitation and the presence of reactive oxygen compounds.

In combination with this photo-oxidative reaction, a catalyst unit, which allows additional decomposition reactions and in which excess ozone is broken down, thus ensuring that the harmful gas ozone does not enter the environment, is connected to the reaction stage.

The catalyst known from EP 0 778 070 B1 is preferably an activated carbon catalyst. The activated carbon that is used is a highly porous material having an internal surface area of approximately 1,200 m²/g, which is used as a reaction surface. The object of the activated carbon is, firstly, to retain compounds that are difficult to oxidise and therefore to increase their retention time in the reactor. The concentration of these components is therefore increased compared to the gas phase, resulting in an increase in the rate of reaction with the formed oxygen species on the activated carbon surface. On the other hand, the use of the activated carbon as a subsequent catalyst ensures that the harmful gas ozone does not enter the environment, as activated carbon acts as an ozone filter.

Tubular UV emitters are conventionally used to generate the UV radiation according to EP 0 778 070 B1. EP 0 778 070 B1 does not specify how the UV emitters may be arranged in the photo-oxidative reaction stage. Nevertheless, corresponding reaction stages, which propose preferred arrangements of the UV emitters, are known from the prior art.

JP 07-060058 A discloses a device for purifying used air containing harmful substances in a used air duct, in which is a UV emitter is arranged in an air conduit, parallel to the direction of flow, and the UV radiation of which has wavelengths both in the range of 185 nm and in the range of 254 nm. JP 07-060058 A also proposes coating the internal walls of the air conduit with titanium dioxide, in order to achieve a catalyst effect in the same reaction stage.

DE 197 40 053 A1 discloses a further device for purifying used air containing harmful substances in a used air duct, in which a plurality of tubular UV emitters are arranged in the photo-oxidative reaction stage, also parallel to the direction of flow. DE 197 40 053 A1 also mentions the additional use of titanium dioxide as a catalyst and proposes, for sufficient interaction between the harmful substances contained in the used air and the UV radiation, corresponding baffle plates and/or perforated plates.

It has been found that the availability of a cost-effective, compact used air purification system is becoming increasingly important, in particular for small production units. Starting from the device known from JP 07-060058 A, the object of the invention is therefore to increase in a simple manner the decomposition rate at which the used air, which is contaminated with harmful substances, is purified and freed from harmful substances within the air conduit, in order thus to be able to provide a cost-effective and compact used air purification system.

This object is achieved by a reaction stage of a used air duct according to claim 1 and a device for purifying used air containing harmful substances according to claim 14.

A fundamental finding of the invention is that improved interaction between the UV radiation, the harmful substances contained in the used air, and the catalyst, which is coated on the internal walls of the air conduit, may be achieved by suitably altering the shape of the cross section of the air conduit known from JP 07-060058 A. JP 07-060058 A proposes a square or rectangular cross section of the air conduit. In contrast thereto, the invention has demonstrated that an increase in the decomposition rate within an air conduit is possible if the cross section of the at least one air conduit is configured as a regular polygon having at least five sides.

### OBJECTS AND SUMMARY OF THE INVENTION

According to a preferred embodiment, it is proposed that a plurality of air conduits is arranged next to one another in a honeycombed configuration. This allows the reaction stage according to the invention to be compact in its construction if a plurality of air conduits is to be arranged parallel to one another.

For the configuration of the honeycombed structure, it is recommended that the cross section of the air conduits be configured as a respective regular hexagon or a regular octagon.

The borderline case of the invention is formed by a cross-section in which the regular polygon is configured as a circle and may therefore effectively consist of an infinite number of sides. From the point of view of the increase in the degree of effectiveness, this borderline case of the circular cross-section is optimal; nevertheless, the interval between various air conduits remains unused if a plurality of air conduits is to be arranged in parallel. The honeycombed structure, with hexagonal or octagonal cross sections, has therefore proven to be a beneficial compromise, for the arrangement in parallel of a plurality of air conduits, between the rectangular cross section known from the prior art and the circular cross section.

According to a preferred embodiment, it is provided that the respective UV emitter is held in the at least one air conduit by means of laterally attached contact rails. The contact rails are preferably configured in such a way that the tubular UV emitters may easily be maintained and exchanged.

According to a further preferred embodiment, it is provided that the radiation emitted by a UV emitter causes the formation of reactive reactants such as ozone and/or oxygen-containing radicals in the used air as it flows along. It is known that such an effect may, in particular, be achieved if the wavelength of the radiation emitted by the respective UV emitter is in the range of 185 nm.

According to a further preferred embodiment, it is provided that the radiation emitted by a UV emitter causes the stimulation of the hydrocarbons contained in the used air to higher energy levels. It is known that such an effect may, in particular, be achieved if the wavelength of the radiation emitted by the respective UV emitter is in the range of 254 nm.

It is therefore particularly advantageous to use UV emitters, the emitted wavelength of which is in the range of the absorption spectra of the gaseous molecules contained in the used air, the use of the wavelength ranges of 185 nm and 254 nm being in this case recommended, as these wavelength ranges are available with conventional mercury vapour lamps. In order at the same time further to reduce the overall size of the reaction stage, an increase in the power of the respectively used UV emitters may also be provided. The light intensity of the more powerful UV emitter must be determined as a function of the wavelength in order for there also to be sufficient overlapping of the absorption spectra of the harmful substance molecules with the emission spectrum of the light source.

A further finding of the invention consists in optimising the wavelengths with respect to the catalyst material that may be used for coating the internal walls of the air conduit, rather than optimising the wavelengths emitted by the UV emitter relative to the absorption spectra of the gaseous molecules contained in the used air. Starting from JP 07-060058 A, this finding of the invention therefore relates to a reaction stage of a used air duct comprising at least one air conduit, in which a tubular UV emitter is arranged longitudinally to the direction of flow of the used air, and the internal walls of which are coated with a broadband semiconductor material as a catalyst material. In JP 07-060058 A, titanium dioxide (TiO₂) is used as the catalyst material.

Starting from the device known from JP 07-060058 A, the present object of the invention, which consists in increasing in a simple manner the decomposition rate at which the used air, which is contaminated with harmful substances, is purified and freed from harmful substances within the air conduit, may be achieved, on the basis of coating the internal walls of the air conduit with a semiconductor material, in that the radiation emitted by the respective UV emitter has wavelengths that are greater than 254 nm and the emitted radiation energy of which is substantially greater than or equal to the energy differential between the valence and conduction bands of the semiconductor material.

In principle, the irradiation of a photosemiconductor with photons, the energy of which is greater than or equal to the energy differential between the valence and conduction bands of the semiconductor, results in the generation of electron-hole pairs. The crucial finding of the invention is that the wavelengths emitted by the UV emitter are particularly effective, in proximity to the absorption edge of the semiconductor, for the implementation of the photocatalytic reactions and result in photocatalytic reactions. It is therefore not the wavelength ranges of 185 nm and 254 nm of conventional mercury vapour lamps, but rather, alternatively or additionally, wavelength ranges having higher wavelengths, the emitted radiation energy of which is correspondingly lower, but nevertheless sufficient to overcome the energy differential between the valence and conduction bands of the semiconductor material, that are decisive.

All semiconductors having band gaps between approximately 2 eV and 4 eV, such as, for example, titanium dioxide (TiO₂), zinc oxide (ZnO), cadmium sulphate (CdS), zirconium dioxide (ZrO₂), tungsten trioxide (WO₃), cerium dioxide (CeO₂), strontium titanium trioxide (SrTiO₃) or zirconium titanium oxide (ZrTiO₄), are, in principle, suitable for this photocatalysis. Titanium dioxide (TiO₂) or else doped titanium dioxide has proven to be particularly suitable, combining effectively, as it does, the characteristics of reactivity, environmental acceptability, long-term stability and also cost-effectiveness. All photosemiconductors may be activated by energy-equivalent light of the wavelengths between 340 nm and 500 nm.

It has generally been found that the desired catalyst effect may be achieved in the range of the reaction stage according to the invention if the internal walls of the air conduit are coated with a broadband semiconductor material as a catalyst material. For the respective UV emitter, it must be ensured that the range of the wavelength of the radiation emitted by the UV emitter is selected in such a way that the emitted radiation energy is at least greater than or equal to the energy differential between the valence and conduction bands of the semiconductor material.

According to a preferred embodiment, the semiconductor material consists in a known manner of titanium dioxide.

However, the semiconductor material may also consist of doped titanium dioxide. As a result of the irradiation of the titanium dioxide or doped titanium dioxide with UV radiation, the energy of which is greater than or equal to the energy differential between the valence and conduction bands of the semiconductor, electron-hole pairs are firstly generated in the semiconductor material. Oxygen-containing radicals, which effectively assist the process of the oxidation of harmful substances, are then formed. It has been found that in order to achieve optimal interaction between the UV radiation and the catalyst material, the distance between the UV emitter and the internal walls of the air conduit is to be taken into account. For the optimisation of an air conduit according to the invention, the distance will therefore always be selected in such a way that, for a given catalyst material and a predetermined UV emitter, an optimal decomposition rate of the respective harmful substances may be achieved. Tests have revealed that, for achieving the catalyst effect with titanium dioxide, the wavelength of the radiation emitted by the respective UV emitter is preferably in the range between 350 nm and 420 nm.

The reaction stage according to the invention may therefore be used to improve the decomposition rate and dimensions of the device known from EP 0 778 070 B1 for the purification of the used air containing harmful substances in a used air duct.

A further solution of the present invention therefore consists in a device for purifying used air containing harmful substances in a used air duct, comprising the above-described reaction stage according to the invention and comprising a catalyst unit following this reaction stage.

This device provides a cost-effective, compact system, which is particularly suitable for low volume flow rates and small production units such as, for example, small enamelling works or restaurants.

According to a preferred embodiment, the catalyst unit consists of an activated carbon catalyst. As described above, the subsequent catalyst unit causes both an increase in the reaction rate of the air stream supplied from the reaction stage and the decomposition of ozone that is still contained in the arriving air stream, but is not intended to be emitted into the environment. If excess ozone therefore reaches the activated carbon surface, it either reacts with the harmful substances adsorbed at the surface or oxidises the carbon of the activated carbon. The latter case entails a loss in energy, as the ozone, which is produced with the aid of light energy, is lost unused, i.e. without having carried out an oxidation of harmful substances.

According to a preferred embodiment, it is therefore proposed to provide a redox system, which reliably prevents ozone from issuing into the environment, but nevertheless stores the oxidation force of the ozone. Potassium permanganate/manganese dioxide are, for example, recommended as a redox pair. As a result of the oxidation of organic harmful substances by potassium permanganate, manganese dioxide, which is, in turn, regenerated as a result of the reaction with ozone to form potassium permanganate, is formed.

It must also be borne in mind, in the provision of the subsequent catalyst unit, that the mixtures of harmful substances that are in practice to be broken down generally consist of a large number of different substances, as harmful substance mixtures comprising one principal component and a plurality of secondary components often have to be disposed of. Moreover, further harmful substances, which also have to be broken down in the subsequent catalyst unit, are constantly produced as a result of the photo-oxidation in the reaction stage. As the oxidation reactions of organic compounds are governed by complex reaction mechanisms, the oxidation of the harmful substances to form CO₂ may often only be achieved by means of a series of several oxidation steps. The polarity of the organic compounds increases over the course of the overall reaction to form the end product CO₂. The complexity of the mixture of harmful substances causes the components to compete for the adsorption sites in the catalyst unit. However, this means that a single adsorber material is no longer able sufficiently to adsorb all of the compounds of a complex mixture of harmful substances. Activated carbon, for example, as a nonpolar adsorber, preferably also absorbs nonpolar harmful substances.

According to a further preferred embodiment, it is therefore provided that the catalyst unit consists of catalysts of different polarities. An additional increase in the decomposition rate may thus be achieved if the harmful substances in the used air supplied from the reaction stage have different polarities.

According to a further preferred embodiment, it is provided that a plurality of units, consisting of a reaction stage and a subsequent catalyst unit, are arranged one behind the other. As a result of the provision of a plurality of catalyst units, each with subsequent reaction stages, the configuration of a used air purification system may be optimised, in the event of the raw gas being contaminated with harmful substances in a non-uniform manner, with respect to the average concentration of harmful substances. If there is only one catalyst unit, the system must be configured with respect to the maximum occurring concentration of harmful substances, thus increasing its size and therefore its cost. However, in the case of enamelling processes, the used gas is contaminated with harmful substances in a non-uniform manner as a result, for example, of the production process. As a result of the use of interposed catalyst units comprising subsequent reaction stages, harmful substance peaks are levelled off and are unable to “break through”. If a harmful substance concentration peak affects a catalyst unit, the harmful substances are adsorbed and reacted on the catalyst surface or are slowly re-emitted to the gas phase, so they may be broken down by a further subsequent reaction stage. The decomposition rate of the overall system may thus be further increased and the system reliably configured even in the event of marked variations in concentration. The arrangement of a plurality of reaction stages and catalyst units, one behind the other, thus ultimately results in a more compact system and therefore a reduction in cost.

### BRIEF DESCRIPTION OF THE DRAWINGS

The invention will be described below in greater detail, on the basis of various embodiments and with reference to the accompanying drawings, in which:

FIG. 1 is the cross section and a perspective view of an air conduit according to the invention;

FIG. 2 is a perspective view of a reaction stage according to the invention comprising a plurality of parallel air conduits; and

FIG. 3 is a perspective view of a used air purification system comprising reaction stages according to the invention.

### DETAILED DESCRIPTION OF THE INVENTION

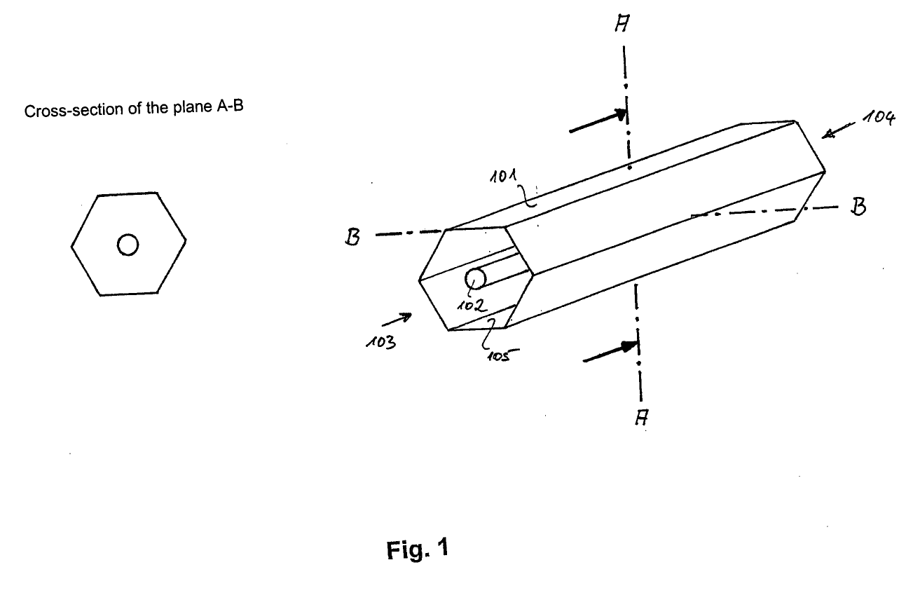

FIG. 1 shows the cross section and a perspective view of an air conduit according to the invention. As may be seen from the cross section of the plane A-B, the air conduit 101 has the cross section of a regular hexagon. A tubular UV emitter 102 is arranged centrally in the air conduit 101. The used air, which is contaminated with harmful substances, enters into the inlet 103 and is re-emitted from the outlet 104. In order to achieve a catalyst effect within the air conduit 101, the internal walls 105 are coated with a broadband semiconductor material, for example titanium dioxide or doped titanium dioxide.

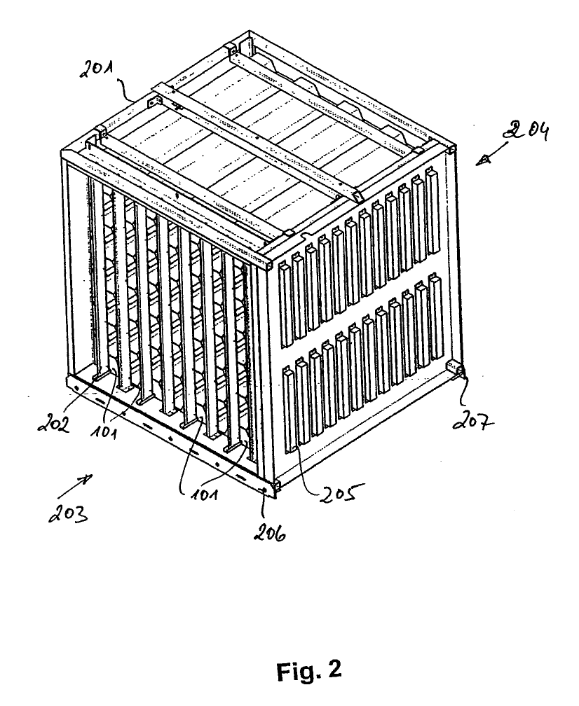

FIG. 2 is a perspective view of a reaction stage according to the invention comprising a plurality of parallel air conduits. The individual air conduits 101 correspond to the air conduit illustrated in FIG. 1 and are arranged in parallel in a honeycombed configuration. A respective tubular UV emitter is arranged, in a corresponding manner, in each air conduit 101. The air conduits 101, which are thus interconnected, are surrounded by a metallic housing and thus form the reaction stage 201. Respective contact rails 202, which, on the one hand, act as cable ducts for the electrical feeds to the UV emitters and, on the other hand, mechanically hold the UV emitters in the air conduits 101, are provided on the air inlet 203 and the air outlet 204. Laterally corresponding series connection units 205 are provided for the electrical activation of the UV emitters. Slide rails 206 and 207 are provided on the lower sides of the reaction stage 201, so the reaction stage 201 in the overall system may be introduced or removed on corresponding rollers for maintenance purposes.

A further improvement in the decomposition rate may be achieved if the internal walls of the air conduit are coated with a catalyst material. As a result of the honeycombed construction of the reaction stage, which comprises a plurality of air conduits, large catalyst surfaces may be provided, with little loss in pressure, in direct proximity to the UV radiation. The direct irradiation of the catalyst surface allows broadband semiconductor materials to be used effectively for photocatalysis. Titanium dioxide has proven particularly suitable as a catalyst material. As a result of the irradiation of the titanium dioxide with UV light, the energy of which is greater than or equal to the energy differential between the valence and conduction bands of the semiconductor, electron-hole pairs are firstly generated in the semiconductor material. O₂— species, which effectively assist the process of the oxidation of harmful substances, are then formed. UV emitters having wavelengths in the range between 340 nm and 420 nm are used for initiating this process.

Gas molecules are then adsorbed on the generated charges of electron-hole pairs formed by light irradiation. The molecules, which are then co-adsorbed, are activated and form a transition state, from which they react to form the end products, while at the same time forming intermediate products. The harmless reaction products desorb and may be emitted to the environment.

The photocatalytic reaction may accordingly be divided into four steps:

1. Generation of the charge pairs

2. Adsorption of the gases on the generated charges

3. Reaction between adjacently adsorbed reactive molecules

4. Desorption of the products

By means of heterogeneous photocatalysis, it is, for example, possible to combust compounds such as ammonia, formaldehyde or lower alcohols, which are difficult to oxidise by means of photo-oxidation, with atmospheric oxygen, with a high degree of effectiveness at ambient temperature, to form nitrogen or CO₂ and water. The course of the reaction, which has already been described in general terms, is in this case as follows:

The used air is directed into a reaction duct, in which titanium dioxide, which is activated by UV light, is located. The irradiation of the photosemiconductor results in the generation of electron/hole pairs. Gas molecules are then adsorbed on the generated charges, wherein the gain in energy during the adsorption process determines which molecules preferably interact with the electrons and which with the holes. In the case of the reaction partners, ammonia and oxygen, ammonia reacts, owing to the respective molecule characteristics, with the holes and oxygen with the electrons. The molecules, which are then co-adsorbed, are activated and form a transition state, from which they react to form the end products, while at the same time forming intermediate products. The harmless reaction products, nitrogen and water, desorb and may be emitted to the environment.

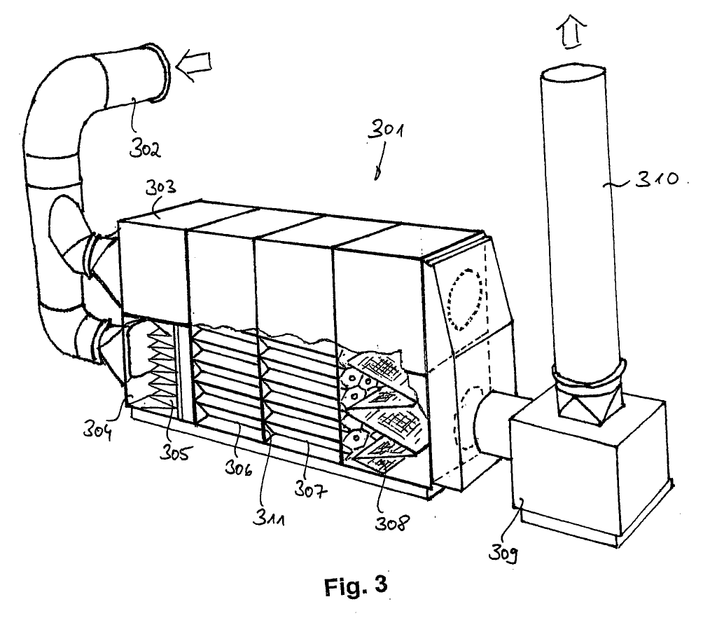

FIG. 3 is a perspective view of a used air purification system 301 comprising reaction stages 306 and 307 according to the invention. The reaction stages 306 and 307 correspond, in each case, to the reaction stage 201 illustrated in FIG. 2. The used air, which contains harmful substances, is supplied to the used air purification system 301 via a supply pipe 302. Two systems 303 and 304, which are identical in construction and are arranged, in the illustration according to FIG. 3, one above the other, may optionally be provided to increase the quantities of air to be purified. For the sake of simplicity, only the system 304, the individual components of which are illustrated in greater detail by means of a cut-away view, will be described below.

A distributor stage 305, which uniformly distributes the arriving air and optionally filters out relatively large harmful substance particles, is accordingly first of all connected to the supply pipe 302. The air forwarded from the distributor stage 305 enters the reaction stages 306 and 307 according to the invention. Two reaction stages 306 and 307, which are identical in the construction, are arranged one behind the other to increase the decomposition rate. However, the used air purification system 301 may, of course, also be constructed with only one reaction stage 306. A catalyst unit 308, which may consist, for example, in the above-described manner of poured, highly porous activated carbon material having an internal surface area of approximately 1,200 m²/g, which may be used as the reaction surface, is connected to the two reaction stages 306 and 307.

The air emitted from the catalyst unit 308 also enters the fan unit 309, which ensures that a suitable difference in pressure is maintained between the supply pipe 302 and the discharge pipe 310.

The used air purification system 301 is, in principle, operated using this method according to EP 0 778 070 B1, although it is, according to the invention, distinguished by one or more reaction stages 306, 307, as is illustrated in FIG. 2. The used air, which is contaminated with harmful substances, accordingly passes from the supply pipe 302, via the distributor stage 304, into the reaction stages 306 307, in which short-wave UVC light initiates a chemical reaction. Odorous substance and harmful substance molecules are broken up. At the same time, harmful substance radicals and ozone are produced as oxidants. The oxidation of the harmful substances produces the environmentally acceptable products CO₂ and H₂O. Compounds that are difficult to oxidise and excess ozone are broken down in the subsequent catalyst unit 308. The purified and non-odorous air is emitted to the environment via the fan unit 309 and the discharge pipe 310.

For the effective treatment of non-uniform harmful substance contaminations, an additional catalyst unit may be interposed in the above-described manner at location 311. The additional, interposed catalyst unit allows even harmful substances that occur briefly, at very high concentrations, to be broken down.

I claim:

1. Reaction stage of a used air duct comprising a plurality of air conduits, in which a respective tubular UV emitter is arranged longitudinally to the direction of flow of the used air,
wherein the cross section of each air conduit is configured as a regular polygon having at least five sides and
wherein the air conduits are arranged next to one another in a honeycombed configuration.

2. Reaction stage according to claim 1, wherein the cross section of the air conduits is configured as a respective regular hexagon.

3. Reaction stage according to claim 1, wherein the cross section of the air conduits is configured as a respective circle.

4. Reaction stage according to claim 1, wherein a UV emitter is held in an air conduit by means of laterally attached contact rails.

5. Reaction stage according to claim 1, wherein the radiation emitted by a UV emitter causes the formation of reactive reactants such as ozone and/or oxygen-containing radicals in the used air as it flows along.

6. Reaction stage according to claim 5, wherein the wavelength of the radiation emitted by the respective UV emitter is in the range of 185 nm.

7. Reaction stage according to claim 1, wherein the radiation emitted by a UV emitter causes the stimulation of the hydrocarbons contained in the used air to higher energy levels.

8. Reaction stage according to claim 7, wherein the wavelength of the radiation emitted by the respective UV emitter is in the range of 254 nm.

9. Reaction stage according to claim 1, wherein the internal walls of the air conduits are coated with a broadband semiconductor material as a catalyst material.

10. Reaction stage according to claim 9, wherein the radiation emitted by the respective UV emitter has wavelengths that are greater than 254 nm and the emitted radiation energy of which is substantially greater than or equal to the energy differential between the valence and conduction bands of the semiconductor material.

11. Reaction stage according to claim 9, wherein the radiation emitted by the respective UV emitter has wavelengths located in the range of the absorption edge of the semiconductor material.

12. Reaction stage according to claim 9, wherein the radiation emitted by the respective UV emitter has wavelengths located in the range between 340 nm and 500 nm, preferably between 350 nm and 420 nm.

13. Reaction stage according to claim 9, wherein the semiconductor material consists of titanium dioxide (TiO₂) or doped titanium dioxide.

14. Reaction stage according to claim 9, wherein the semiconductor material consists of zinc oxide (ZnO), cadmium sulphate (CdS), zirconium dioxide (ZrO₂), tungsten trioxide (WO₃), cerium dioxide (CeO₂), strontium titanium trioxide (SrTiO₃) or zirconium titanium oxide (ZrTiO₄).

15. Device for purifying used air containing harmful substances in a used air duct,
comprising a reaction stage of said used air duct with a plurality of air conduits, in which a respective tubular UV emitter is arranged longitudinally to the direction of flow of the used air,
wherein the cross section of each air conduit is configured as a regular polygon having at least five sides and
wherein the air conduits are arranged next to one another in a honeycombed configuration, and
comprising a catalyst unit following the reaction stage.

16. Device according to claim 15, wherein the catalyst unit consists of an activated carbon catalyst.

17. Device according to claim 15, wherein the catalyst unit is based on a redox system.

18. Device according to claim 17, wherein the redox system is formed by the components potassium permanganate/manganese dioxide.

19. Device according to claim 15, wherein the catalyst unit consists of catalysts of different polarities.
